(19) United States
(12) Patent Application Publication
(10) Pub. No.: US 2004/0226009 A1
(43) Pub. Date: Nov. 11, 2004

(54) System and method for software application task abstraction

(75) Inventors: John C. Mese, Cary, NC (US); Nathan J. Peterson, Raleigh, NC (US); Rod David Waltermann, Durham, NC (US)

Correspondence Address: IBM CORPORATION, PO BOX 12195, DEPT 9CCA, BLDG 002, RESEARCH TRIANGLE PARK, NC, 27709, US

(73) Assignee: International Business Machines Corporation, Armonk, NY

(21) Appl. No.: 10/434,557

(22) Filed: May 9, 2003

(51) Int. Cl. G06F 9/445; G06F 15/16

(52) U.S. Cl. 717/174; 709/247

(57) ABSTRACT

A system and method is provided for abstracting the installation parameters used by tools from reference files written for a particular tool. The generic parameters file can be altered without affecting individual tool reference files. The generic installation parameters file includes parameter data for one or more software installations. Tool reference files are written for each supported tool. These files define the name of the executable that corresponds with the tool as well as the parameter syntax for passing passwords, target locations, input file names, and the like to the defined executable. The extraction tool reference files can also include parameters indicating whether a particular parameter is required, optional, or a constant, and whether a particular parameter can be iteratively received.

### BACKGROUND OF THE INVENTION

1. Technical Field

The present invention relates in general to a system and method for abstracting software application tasks. More particularly, the present invention relates to a system and method for using generic installation parameter files to support a variety of software extraction tools.

2. Description of the Related Art

Software developers and distributors often distribute software in compressed files stored on media such as CD-ROMs, floppy disks, other magnetic media. In addition, using the Internet, more companies are distributing compressed files over the Internet directly to customer machines. Compression of software files allows the many files to be bundled into a single compressed file. Furthermore, compressed files can be password protected so that only a person or a process with knowledge of the password is able to extract the files.

While distributing software in a compressed format is advantageous, certain challenges are introduced into the distribution process. Many different types of extraction tools are available to extract compressed file. Compressed files are often in a standard format so that many of the extraction tools are able to extract files from a common compressed file. A challenge, however, is that extraction tools do not share the same syntax for processing the extraction file. For example, one extraction tool may use a parameter of “/pwd=” to indicate a password, while another extraction tool uses a parameter of “/p=” to indicate the same thing. In other words, while both extraction tools handle passwords as input parameters, the parameter names are different causing incompatibilities between the two extraction tools. In addition, extraction tools are not invoked using the same command. One extraction tool correspond with a command such as “extract.exe,” while another extraction tool corresponds with a command named “pkzip.exe.”

One solution is for the software distributor to require a particular file extraction tool to be used by its customers. A challenge of this approach, however, is that customers, especially larger institutional customers, may have a site license to use a particular extraction tool, but not have a license to use the extraction tool chosen by the software distributor.

Another solution is for the software distributor to package software using a multitude of extraction tools and then ship the version matching the extraction tool used by a particular customer. One challenge of this approach is that the software distributor may require multiple licenses to the multitude of extraction tools, thus increasing licensing fees and distribution costs. Another challenge of this approach is difficulty in maintaining the various versions. For example, if a change is needed to the installation, the same change needs to be made in each of the installation files corresponding to each of the supported extraction tools.

What is needed, therefore, is a system and method for abstracting the parameters used when extracting files from a compressed file from tool reference files used to extract files using a particular extraction tool. Furthermore, what is needed is a system and method that allows iteration of parameters as well as an indication as to whether a particular parameter is optional or required.

### SUMMARY

It has been discovered that the aforementioned challenges are resolved by a system and method that abstracts the installation parameters used by tools from reference files written for a particular tool. In this manner, the generic parameters file can be altered due to distribution needs without affecting individual tool reference files. The tool can be used to copy files, move files, apply software patches, modify files, delete files, extract files from a package file, and launch an installation program.

The generic installation parameters file includes parameter data for one or more software installations. The generic installation parameters file includes generic parameters such as the name of the file containing the files to be acted upon, the password needed to open the compressed file, and a target location to which the files are to be installed.

Tool reference files are written for each supported tool. These files define the name of the executable that corresponds with the tool, such as a copy file command, extraction command, installation command, and the like, as well as the parameter syntax for passing passwords, target locations, input file names, and the like to the defined executable. In addition, the tool reference files include parameters indicating whether a particular parameter is required, optional, or a constant, as well as whether a particular parameter can be iteratively received.

The tool reference file corresponding with the customer's chosen tool is paired with the generic installation parameters file. A program processes the files with the results being a command complete with parameter syntax correct for the chosen tool as well as parameter values, such as passwords, an input filenames, and target locations, retrieved from the generic parameters file. The fully qualified command is executed, resulting in files being acted upon. For example, in an extraction setting, files are extracted from a compressed installation file and stored on the customer's computer system.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings.

FIG. 1 is a block diagram of an installation parameters file and extraction tool reference files being created by a software distributor;

FIG. 2 is a diagram showing sample contents of extraction tool references files and a generic installation parameters file along with the resulting extraction execution commands;

FIG. 3 is a flowchart showing the steps taken to process an extraction tool reference file;

FIG. 4 is a flowchart showing the steps taken to process a parameter found in the extraction tool reference file; and

FIG. 5 is a block diagram of a computing device capable of implementing the present invention.

### DETAILED DESCRIPTION

The following is intended to provide a detailed description of an example of the invention and should not be taken to be limiting of the invention itself. Rather, any number of variations may fall within the scope of the invention, which is defined in the claims following the description.

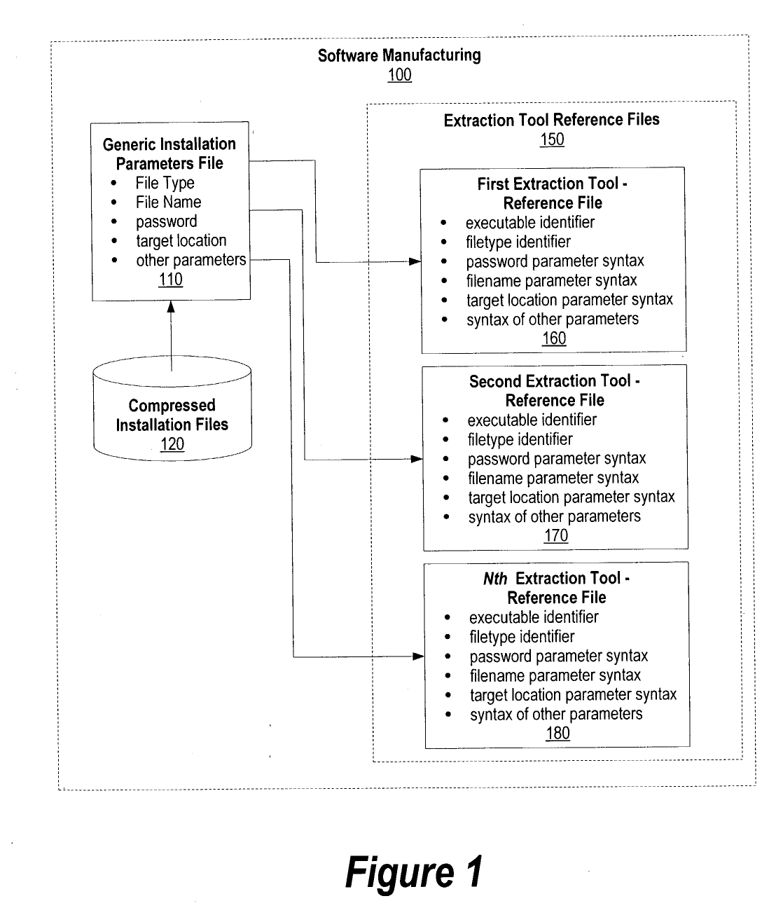

FIG. 1 is a block diagram of an installation parameters file and extraction tool reference files being created by a software distributor. Software manufacturing entity 100 compresses installation files and creates compressed installation files 120. When extracted, these files are the executables and data files needed for a software product being distributed by the software manufacturing entity.

Generic installation parameters file 110 is created. The generic installation parameters file includes generic data that is used by software extraction tools to successfully extract compressed installation files from data store 120. Generic parameters may include the file name and type of the compressed installation file, the password needed to extract files from the compressed installation file, the target location to which the files are stored on the customer's computer system, as well as any other parameter data that may be needed to install the files.

A extraction tool reference file is created for each extraction tool supported by the software manufacturer. Extraction tool references files 150 represents a library of various extraction files that have been written for the various extraction tools. In the example shown, first extraction tool reference file 160, second extraction tool reference file 170, and N^{th} extraction tool reference file 180 each include data pertaining to a particular extraction tool. The data included in extraction tool reference files includes the name of the executable that is used to invoke the extraction tool, a file type identifier, the syntax used to provide a password to the extraction tool, the syntax used to provide an input filename to the extraction tool, the syntax used to provide a target location to the extraction tool, as well as syntax of other parameters supported by the extraction tool.

While the example shown in FIG. 1, as well as other examples shown herein, describe the use of abstraction techniques for extracting files from a package file, the abstraction techniques can also be used for other activities performed when loading files onto a computer system. For example, the generic installation parameters file could contain a list of files that are to copied from one nonvolatile storage device to another and the extraction tool reference files could identify the copy file command executables and parameter syntax used to process the list of files. One computer system may use an executable named “copyfile,” another may use an executable named “copy,” while a third may use an executable named “cf.” The file extraction techniques can analogously be used to move files, apply patches to files, modify or delete files, as well as to launch an installation routine. In launching an installation routine, the parameters file might include installation parameters while the extraction tool reference files would include the name of the installation command on various computer systems and the parameter syntax used by the various installation commands. For example, one computer system may use an installation command named “setup,” while another might use an installation command named “install.”

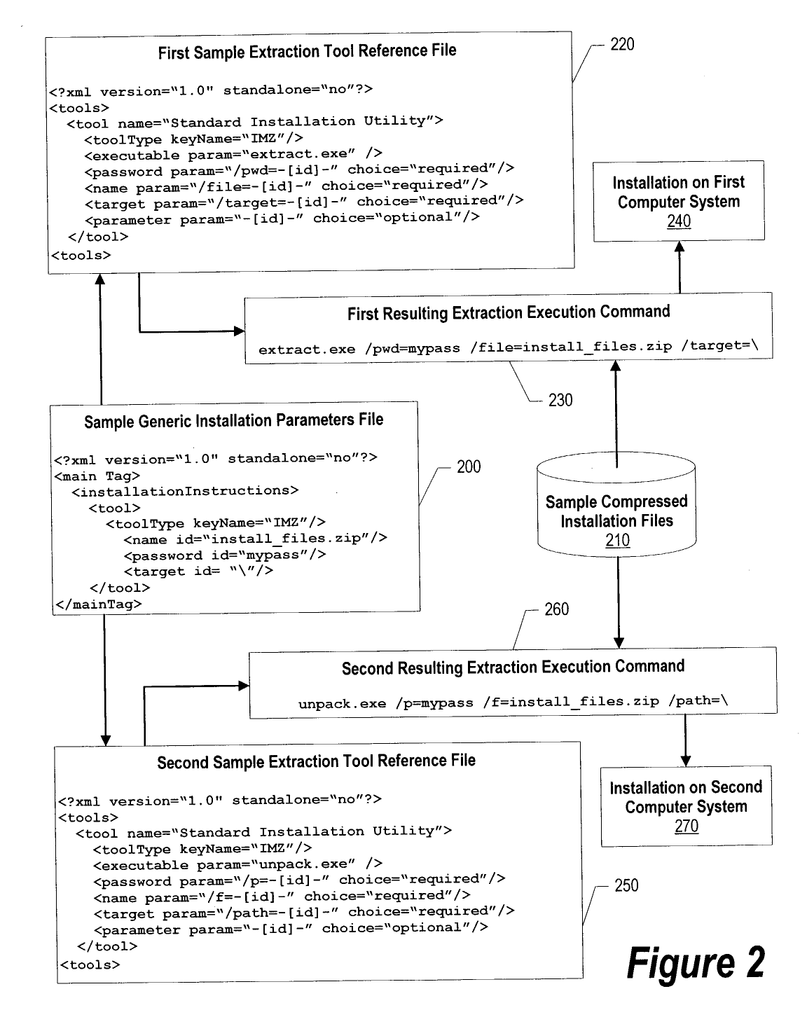

FIG. 2 is a diagram showing sample contents of extraction tool references files and a generic installation parameters file along with the resulting extraction execution commands. In this example, sample generic installation parameters file 200 is used to provide input to two different extraction tool reference files: extraction tool reference file 220 and extraction tool reference file 250. The result of using extraction tool reference file 220 is extraction execution command 230, while the result of using extraction tool reference file 250 is extraction execution command 260. Either of these execution commands can be executed (so long as they exist on the customer's computer system) to extract files from compressed file 210 and install the extracted files on the customer's computer systems, 240 and 270, respectively.

Generic installation parameters file 200 has an extraction tool type key name of “IMZ.” This key name is matched against key names located in extraction tool references file to identify a section of the extraction tool reference file that matches the section of the installation parameters file.

In the example shown, three pieces of information are being provided in the generic installation parameters guide. First, the input file name is identified by the parameter line “<name id=”install_files.zip”/>.” This identifies the name of the compressed file as being install_files.zip. Second, the password needed to extract the files from the compressed file is identified by the parameter line “<password id=“mypass”/>.” This identifies the password as being “mypass.” And third, the target location to which the files are to be stored on the customer's computer system is identified by the parameter line “<target id=“\”/>.” This identifies the target installation location to be the customer's root (\) directory.

Extraction tool reference file 220 includes data specific to a particular extraction tool. The executable used by the extraction tool is identified by the line “<executable param=“extract.exe” />.” The syntax for passing the password to the command is identified by the line “<password param=“/pwd=-[id]-” choice=“required”/>.” This indicates that the parameter “/pwd=” is followed by the password, where “-[id]-” signifies a placeholder for the password variable that is provided by the generic installation parameters file. The syntax for passing the input filename to the command is identified by the line “<name param=“/file=-[id]-” choice=“required”/>.” This indicates that the parameter “/file=” is followed by the input filename (the name of the compressed file), where “-[id]-” once again signifies a placeholder for the variable (filename) that is provided by the generic installation parameters file. The syntax for providing the target location to the command is identified by the line “<target param=“/target=-[id]-” choice=“required”/>.” This indicates that the parameter “/target=” is followed by the target location (i.e., the directory on the customer's computer system to which the files are stored). For each of the parameters, the ‘choice=“required”’ option indicates that the given parameter is required.

Extraction tool 250 also includes syntax for parameters used in conjunction with its executable command (unpack.exe). The syntax for its password parameter is “/p=” followed by the password. Its input filename syntax is “/f=” followed by the filename of the input file. And the syntax for its target path is “/path=” followed by the target path.

The system builds extraction execution commands 230 and 260 by retrieving the data specific to the extraction tool, namely the executable filename and the parameter syntax, from the extraction tool reference files, 220 and 250, respectively, and combining the retrieved extraction tool specific data with installation parameters retrieved from installation parameters file 200. Note that the parameter values (“mypass,” “install_files.zip,” and target of “\”) are used in both execution commands 230 and 260.

In the example shown, the first computer system uses the extraction command “extract.exe.” Therefore, the first extraction execution command 230, when executed, uses the extract.exe command to install files from compressed file 210 onto first computer system 240. Likewise, the second computer system uses the extraction command “unpack.exe.” Consequently, the second extraction execution command 260, when executed, uses the unpack.exe command to install the same files onto second computer system 270.

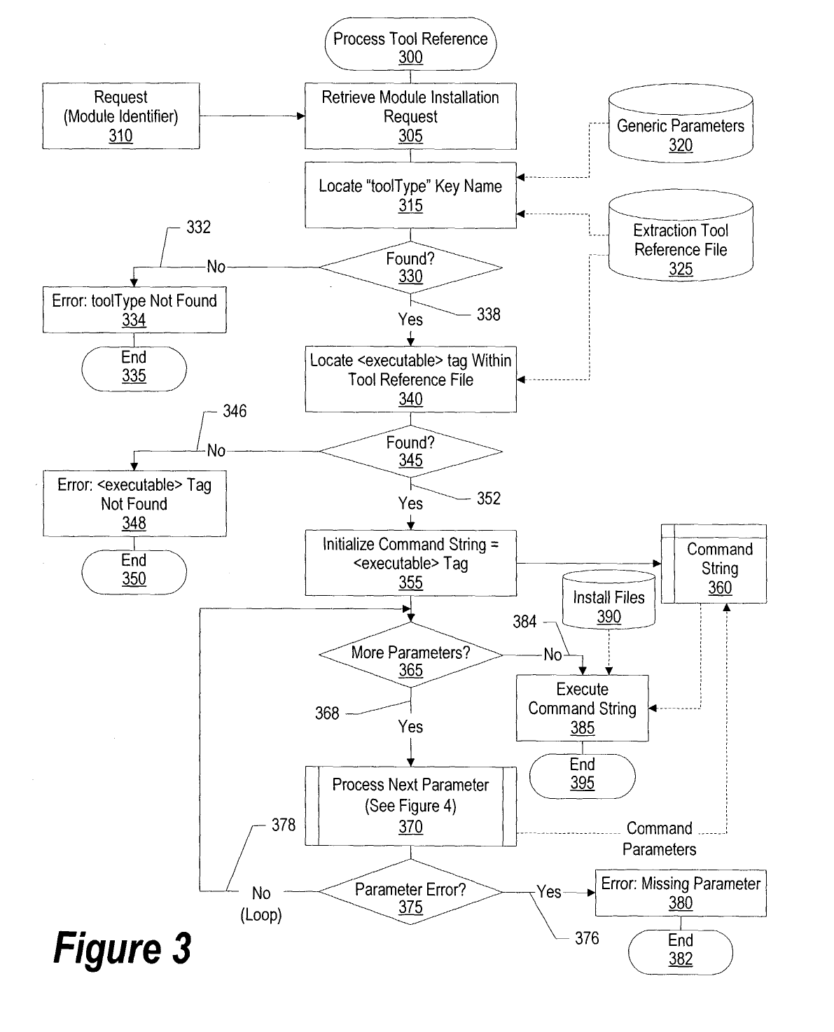

FIG. 3 is a flowchart showing the steps taken to process an extraction tool reference file. Processing commences at 300, whereupon request 310 is received to install a particular module, such as a software product, identified by a module identifier (step 305).

The generic parameters file (data store 320) and the extraction tool reference file (data store 325) are both searched for a tool type matching the provided module identifier (step 315). A determination is made as to whether the module identifier was found in both the generic parameters file and the extraction tool reference file (decision 330). If the identifier was not found in both files, decision 330 branches to “no” branch 332 whereupon an error is returned indicating that a tool type was not found matching the requested module identifier (step 334) and processing ends at 335.

On the other hand, if the identifier was found in both files, decision 330 branches to “yes” branch 338 whereupon the executable tag is located in the extraction tool reference file (step 340). A determination is made as to whether an executable tag was found (decision 345). If an executable tag was not found, decision 345 branches to “no” branch 346 whereupon an error is returned indicating that the name of the executable for the extraction tool could not be found (step 348) and processing ends at 350.

On the other hand, if the name of the executable was found, decision 345 branches to “yes” branch 352 whereupon command string 360 is initialized to the name of the executable (step 355). The command string will continue to be modified as more parameter syntax and parameter values are retrieved from the extraction tool reference file and the generic parameters file, respectively, and appended to the command string.

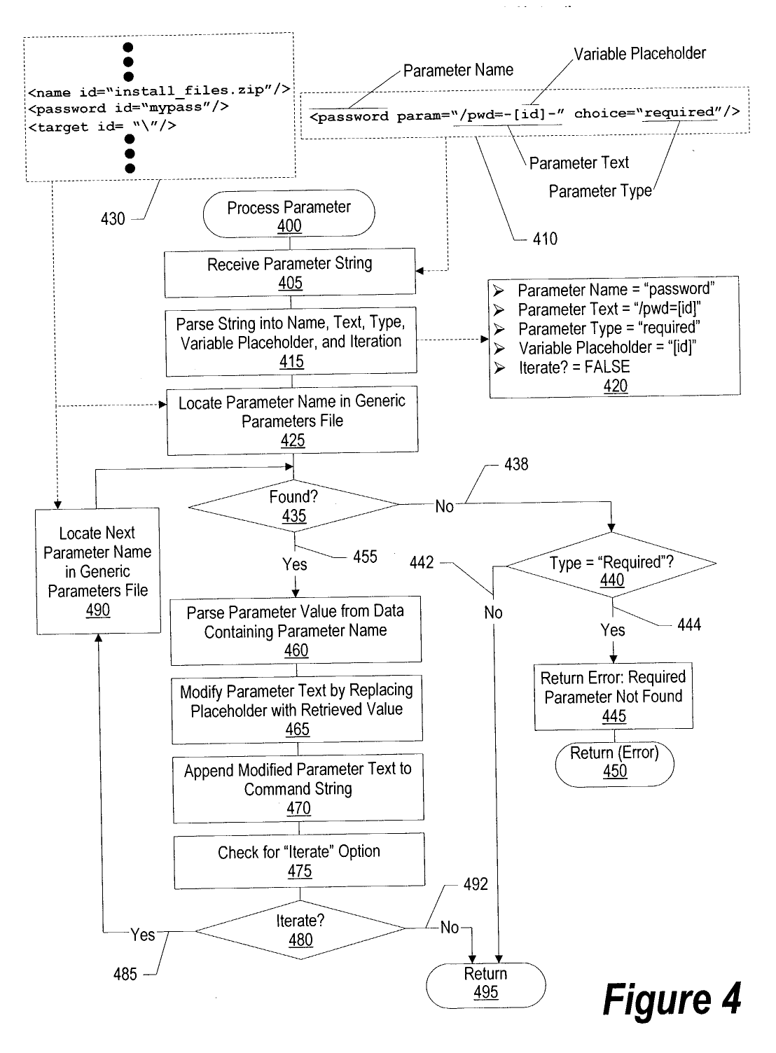

A determination is made as to whether there are more parameters to process (decision 365). This determination is made by checking if there are additional parameters in the extraction tool reference file before reaching the end of the tool definition. If there are more parameters, decision 365 branches to “yes” branch 368 whereupon the next parameter found in the extraction tool reference file is processed (Predefined Process 370, see FIG. 4 and corresponding text for processing details). The results of processing the next command are appended onto command string 360.

Another determination is made as to whether an error occurred while processing the parameter (decision 375). If an error occurred, decision 375 branches to “yes” branch 376 whereupon an error is returned indicating that a required parameter is missing (step 380) and processing ends at 382. On the other hand, if an error did not occur, decision 375 branches to “no” branch 378 which loops back to determine if there are more parameters to process. This looping continues until all parameters have been processed, at which time decision 365 branches to “no” branch 384.

The fully formed command string, stored in memory area 360, is executed (step 385). In one embodiment, the fully formed command string extracts files from a compressed file and stores them on a nonvolatile storage device. Processing thereafter ends at 395.

FIG. 4 is a flowchart showing the steps taken to process a parameter found in the extraction tool reference file. This process is called by predefined process 370 shown in FIG. 3. In FIG. 4, processing commences at 400 whereupon parameter string 410, retrieved from the extraction tool reference file, is received (step 405). The received parameter string is parsed (step 415) in order to identify parameter components 420. Parameter components include the parameter name, the parameter text, the parameter type, the variable placeholder, and options such as whether the parameter is iterative (i.e., possibly more than one parameter value to retrieve from the generic parameters file).

Generic parameters file 430 is searched for the retrieved parameter name (step 425). A determination is made as to whether the parameter name was found in the generic parameters file (decision 435). If the parameter name was not found, decision 435 branches to “no” branch 438 whereupon another determination is made as to whether the parameter is required (decision 440). If the parameter is not required, decision 440 branches to “no” branch 442 and processing returns at 495. On the other hand, if the parameter is required, decision 440 branches to “yes” branch 444 whereupon an error is returned indicating that a required parameter was not found in the generic parameters file (step 445) and processing returns with an error at 450.

Returning to decision 435, if the parameter was found in the generic parameters file, decision 435 branches to “yes” branch 455 whereupon steps 460 through 475 are performed. In step 460, the parameter value is parsed from the line in the generic parameters file that contains the parameter name. In step 465, the parameter text retrieved from the extraction tool reference file is modified by replacing the variable placeholder with the parameter value retrieved from generic parameters file 430. In step 470, the modified parameter text is appended to the command string. Finally, in step 475, options such as whether the parameter is iterative are checked.

A determination is made as to whether this parameter is iterative (decision 480). If it is not iterative, decision 480 branches to “no” branch 492 and processing returns at 495. On the other hand, if it is iterative, decision 480 branches to “yes” branch 485 whereupon a search is made for the next matching parameter name in the generic parameters file (step 490) and processing loops back to determine whether the parameter name was found, and if so, process the parameter value. This looping continues until no additional matching parameter names are found in the generic parameters file, at which point decision 435 branches to “no” branch 438 and processing returns at 495.

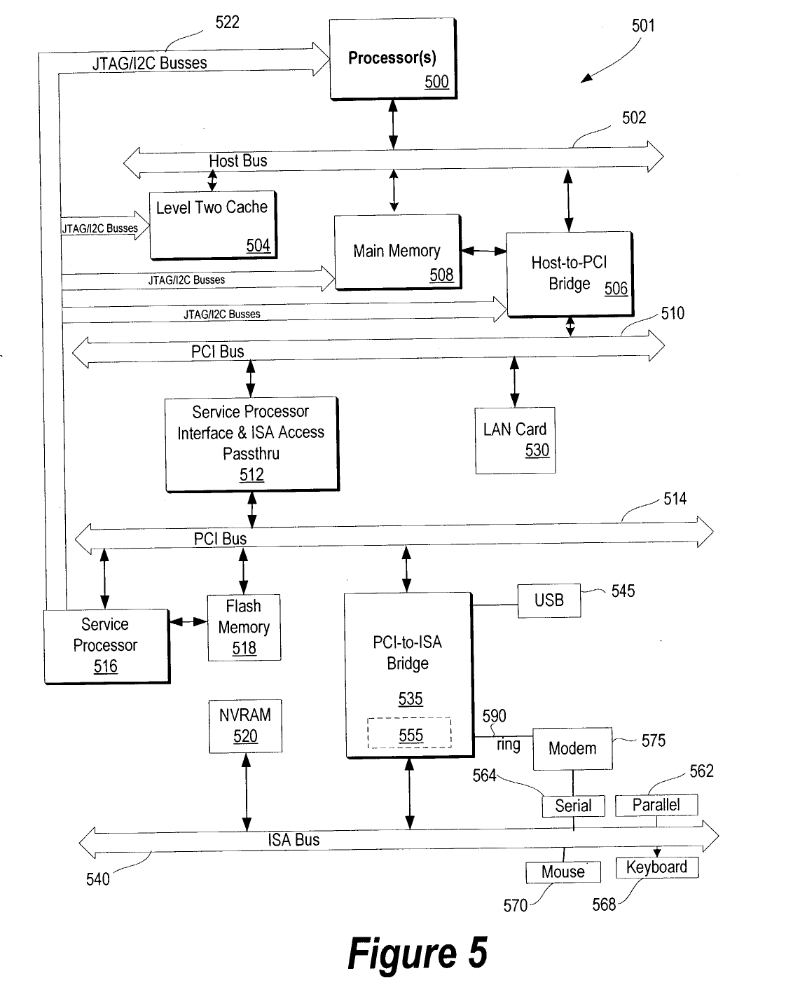

FIG. 5 illustrates information handling system 501 which is a simplified example of a computer system capable of performing the computing operations described herein. Computer system 501 includes processor 500 which is coupled to host bus 502. A level two (L2) cache memory 504 is also coupled to host bus 502. Host-to-PCI bridge 506 is coupled to main memory 508, includes cache memory and main memory control functions, and provides bus control to handle transfers among PCI bus 510, processor 500, L2 cache 504, main memory 508, and host bus 502. Main memory 508 is coupled to Host-to-PCI bridge 506 as well as host bus 502. Devices used solely by host processor(s) 500, such as LAN card 530, are coupled to PCI bus 510. Service Processor Interface and ISA Access Pass-through 512 provides an interface between PCI bus 510 and PCI bus 514. In this manner, PCI bus 514 is insulated from PCI bus 510. Devices, such as flash memory 518, are coupled to PCI bus 514. In one implementation, flash memory 518 includes BIOS code that incorporates the necessary processor executable code for a variety of low-level system functions and system boot functions.

PCI bus 514 provides an interface for a variety of devices that are shared by host processor(s) 500 and Service Processor 516 including, for example, flash memory 518. PCI-to-ISA bridge 535 provides bus control to handle transfers between PCI bus 514 and ISA bus 540, universal serial bus (USB) functionality 545, power management functionality 555, and can include other functional elements not shown, such as a real-time clock (RTC), DMA control, interrupt support, and system management bus support. Nonvolatile RAM 520 is attached to ISA Bus 540. Service Processor 516 includes JTAG and I2C busses 522 for communication with processor(s) 500 during initialization steps. JTAG/I2C busses 522 are also coupled to L2 cache 504, Host-to-PCI bridge 506, and main memory 508 providing a communications path between the processor, the Service Processor, the L2 cache, the Host-to-PCI bridge, and the main memory. Service Processor 516 also has access to system power resources for powering down information handling device 501.

Peripheral devices and input/output (I/O) devices can be attached to various interfaces (e.g., parallel interface 562, serial interface 564, keyboard interface 568, and mouse interface 570 coupled to ISA bus 540. Alternatively, many I/O devices can be accommodated by a super I/O controller (not shown) attached to ISA bus 540.

In order to attach computer system 501 to another computer system to copy files over a network, LAN card 530 is coupled to PCI bus 510. Similarly, to connect computer system 501 to an ISP to connect to the Internet using a telephone line connection, modem 575 is connected to serial port 564 and PCI-to-ISA Bridge 535.

While the computer system described in FIG. 5 is capable of executing the processes described herein, this computer system is simply one example of a computer system. Those skilled in the art will appreciate that many other computer system designs are capable of performing the processes described herein.

One of the preferred implementations of the invention is a client application, namely, a set of instructions (program code) in a code module that may, for example, be resident in the random access memory of the computer. Until required by the computer, the set of instructions may be stored in another computer memory, for example, in a hard disk drive, or in a removable memory such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the. required method steps.

While particular embodiments of the present invention have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that is a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A method for loading files on a computer system, said method comprising:
identifying a tool command name stored in a first file;
retrieving one or more parameter strings from the first file, the parameter strings each including a parameter name;
locating one or more of the retrieved parameter names in a second file;
obtaining, from the second file, parameter values corresponding to the located parameter names;
building a command string, the command string including the tool command name and the obtained parameter values; and
executing the command string, the executing resulting in the extraction of the files from the package file.

2. The method of claim 1 further comprising:
retrieving a parameter text from each of the parameter strings; and
including the parameter text in the command string.

3. The method of claim 1 wherein the tool command is selected from the group consisting of a copy file command, a move file command, a program patch command, a file modification command, a file deletion command, a file extraction command, and a program installation command.

4. The method of claim 1 wherein the parameter string includes a parameter type, wherein the parameter type is selected from the group consisting of a required parameter, an optional parameter, and a constant value.

5. The method of claim 1 wherein the parameter string identifies that the parameter is required, the method further comprising:
determining whether the parameter name exists in the second file; and
returning an error in response to the parameter name not existing in the second file.

6. The method of claim 1 wherein the parameter string identifies that the parameter is iterative, the locating further comprising:
searching for a plurality of matching parameter names in the second file; and
obtaining the parameter value for each of the plurality of matching parameter names found in the second file.

7. The method of claim 1 further comprising:
retrieving a parameter text from each of the parameter strings, the parameter text including a variable placeholder;
replacing each of the variable placeholders with the obtained parameter value corresponding to the parameter name; and
for each of the parameter strings, appending the parameter text that includes the obtained parameter value to the command string.

8. An information handling system comprising:
one or more processors;
a memory accessible by the processors;
a nonvolatile storage device accessible by the processors; and
an tool for loading files on a computer system, the tool being effective to:
identify a tool command name stored in a first file;
retrieve one or more parameter strings from the first file, the parameter strings each including a parameter name;
locate one or more of the retrieved parameter names in a second file;
obtain, from the second file, parameter values corresponding to the located parameter names;
build a command string, the command string including the tool command name and the obtained parameter values; and
execute the command string, the execution resulting in the extraction of the files from the package file.

9. The information handling system of claim 8 wherein the tool is further effective to:
retrieve a parameter text from each of the parameter strings; and
include the parameter text in the command string.

10. The information handling system of claim 8 wherein the tool command is selected from the group consisting of a copy file command, a move file command, a program patch command, a file modification command, a file deletion command, a file extraction command, and a program installation command.

11. The information handling system of claim 8 wherein the parameter string identifies that the parameter is required, and wherein tool is further effective to:
determine whether the parameter name exists in the second file; and
return an error in response to the parameter name not existing in the second file.

12. The information handling system of claim 8 wherein the parameter string identifies that the parameter is iterative, and wherein the tool is further effective to:
search for a plurality of matching parameter names in the second file; and
obtain the parameter value for each of the plurality of matching parameter names found in the second file.

13. The information handling system of claim 8 wherein the tool is further effective to:
retrieve a parameter text from each of the parameter strings, the parameter text including a variable placeholder;
replace each of the variable placeholders with the obtained parameter value corresponding to the parameter name; and
for each of the parameter strings, append the parameter text that includes the obtained parameter value to the command string.

14. A computer program product stored in a computer operable media for loading files on a computer system, wherein the computer program product is adapted to:
identify a tool command name stored in a first file;
retrieve one or more parameter strings from the first file, the parameter strings each including a parameter name;
locate one or more of the retrieved parameter names in a second file;
obtain, from the second file, parameter values corresponding to the located parameter names;
build a command string, the command string including the tool command name and the obtained parameter values; and
execute the command string, the execution resulting in the extraction of the files from the package file.

15. The computer program product of claim 14 wherein the computer program product is further adapted to:
retrieve a parameter text from each of the parameter strings; and
include the parameter text in the command string.

16. The computer program product of claim 14 wherein the tool command is selected from the group consisting of a copy file command, a move file command, a program patch command, a file modification command, a file deletion command, a file extraction command, and a program installation command.

17. The computer program product of claim 14 wherein the parameter string includes a parameter type, wherein the parameter type is selected from the group consisting of a required parameter, an optional parameter, and a constant value.

18. The computer program product of claim 14 wherein the parameter string identifies that the parameter is required, and wherein the computer program product is further adapted to:
determine whether the parameter name exists in the second file; and
return an error in response to the parameter name not existing in the second file.

19. The computer program product of claim 14 wherein the parameter string identifies that the parameter is iterative, and wherein the computer program product is further adapted to:
search for a plurality of matching parameter names in the second file; and
obtain the parameter value for each of the plurality of matching parameter names found in the second file.

20. The computer program product of claim 14 wherein the computer program product is further adapted to:
retrieve a parameter text from each of the parameter strings, the parameter text including a variable placeholder;
replace each of the variable placeholders with the obtained parameter value corresponding to the parameter name; and
for each of the parameter strings, append the parameter text that includes the obtained parameter value to the command string.
